(19) United States
(12) Patent Application Publication
(10) Pub. No.: US 2016/0090934 A1
(43) Pub. Date: Mar. 31, 2016

(54) METHOD AND SYSTEM FOR CONTROLLING ELECTRONIC THROTTLE CONTROL SYSTEM

(71) Applicant: HYUNDAI MOTOR COMPANY, Seoul (KR)

(72) Inventor: Jung-Wook NA, Hwaseong-si (KR)

(21) Appl. No.: 14/556,084

(22) Filed: Nov. 28, 2014

(30) Foreign Application Priority Data
Sep. 25, 2014 (KR) 10-2014-0128246

(51) Int. Cl. F02D 41/24

(52) U.S. Cl. CPC F02D 41/2438; F02D 41/2451

(57) ABSTRACT

A method for controlling an electronic throttle control (ETC) system, in which an electronic control unit (ECU) controls the ETC system using an air volume learning value containing information on a volume of air introduced into an engine for each opening degree of the ETC system according to carbon deposit of the ETC system, the method may include reading an air volume learning value used during a previous operation. The air volume learning value is compared to a preset learning value change reference value. Whether an operation condition of the engine satisfies a learning value change condition which is preset to change the air volume learning value, and whether the volume of air passing through the ETC system satisfies a preset learning-value-change-air-volume condition are determined. The air volume learning value used during the previous operation and stored in the ECU is substituted with a preset initial value of the air volume learning value.

### CROSS-REFERENCE TO RELATED APPLICATIONS

This application claims the benefit of priority to Korean Patent Application No. 10-2014-0128246, filed on Sep. 25, 2014, which is incorporated herein by reference in its entirety.

### TECHNICAL FIELD

The present disclosure relates to a method and system for controlling an electronic throttle control (ETC) system which controls a volume of air introduced into an engine, and particularly, to a method and system for controlling an ETC system of which carbon deposit is changed, capable of preventing engine hesitation or ignition-off.

### BACKGROUND

In a vehicle to which a gasoline engine is applied, a variety of fuel trim operations are performed to achieve an optimal air/fuel ratio for a volume of air introduced into a cylinder of the engine.

Furthermore, an optimal volume of air required for controlling the engine must be controlled to be introduced into the engine. In recent gasoline engines, most of the volume of air introduced into an engine is adjusted by an opening degree of an electronic throttle control (ETC) system, and the opening degree of the ETC system is controlled by an electronic control unit (ECU).

As illustrated in FIGS. 1A and 1B, an ECU 11 calculates a torque required for operating a vehicle from a current vehicle speed and an operation amount of an accelerator pedal, and applies the torque as a power train torque which must be exhibited by a power train. Hereafter, the torque required for operating the vehicle will be referred to as a vehicle torque requirement. When a transmission gear ratio is applied to the power train torque, an engine torque to be exhibited by the engine may be calculated. The vehicle torque requirement includes torques for controlling an electronic stability control (ESC), a clutch and a differential gear, and the power train torque is calculated in consideration of the transmission gear ratio, the gear operation, and a torque loss in the power train. The engine torque is finally calculated in consideration of an accessory torque and a restriction torque for driving various engine and vehicle devices.

When the engine torque is calculated, the engine is controlled to generate the engine torque through a torque filter and a torque path. For example, the volume of air introduced into the engine, the volume of fuel injected in the cylinder, ignition timing, fuel-cut timing, and the like may be set to control the engine to finally generate the engine torque.

During combustion control for the engine, the volume of fuel injected from an injector, the ignition timing and the like are controlled as important factors according to the volume of air introduced into the engine, in order to achieve a target air/fuel ratio. The volume of air introduced into the engine is calculated as the volume of air to be introduced into each cylinder of the engine, and converted into a throttle opening degree by an ETC system 12 to determine a target opening degree. Then, the ETC system 12 is controlled according to the target opening degree.

The opening degree of the ETC system is not set to a fixed value, but corrected through learning in consideration of a process deviation and carbon deposit based on a default opening degree which is set according to the air volume. Then, the corrected opening degree is used for controlling the opening degree of the ETC system.

For example, when carbon is deposited in the intake manifold, or particularly the ETC system, the carbon deposit may reduce the cross-sectional area through which air is passed. Thus, as the carbon deposit increases, the opening degree must be increased to introduce the target volume of air into the engine. In particular, a larger amount of carbon is deposited in a gasoline direct injection (GDI) engine than in a general gasoline engine. Thus, the air volume is corrected by continuously learning the opening degree-air volume relation based on the carbon deposit.

The air volume is learned in real time. When a rapid change occurs in the air volume, engine hesitation or ignition-off may occur. Thus, in order to prevent the engine hesitation or ignition-off, the air volume is continuously learned over a long period of time. The air volume learning value is stored when ignition is turned off, and then reflected when the engine is started next time. When carbon cleaning is performed or the ETC system is replaced during engine stop, the existing air volume learning value may be used even though the carbon deposit was varied. In this case, since the air volume learning value is set to correct the air volume based on the existing carbon deposit, a larger volume of air than the target air volume may be introduced into the engine.

Before the carbon cleaning, an actual volume of air, close to the target air volume calculated by reflecting the air volume learning value, is introduced into the engine. After the carbon cleaning, however, a larger volume of air than the target air volume is introduced into the engine, when the ETC system is opened. Thus, an engine revolutions per minute (RPM) is further increased.

As the previously stored air volume learning value increases, the RPM is destabilized when the engine starts after the carbon deposit of the ETC system 12 is cleaned.

Thus, when a larger volume of air than the target air volume is introduced into the engine, a negative pressure may be lowered to degrade the performance of the brake using the negative pressure of the engine. Thus, the air volume learning value is limited so as not to be smaller than a preset value for safety.

Furthermore, while learning is performed to equalize the target air volume and the actual air volume, the control for the air/fuel ratio may be destabilized. In this case, engine hesitation or ignition-off may occur. The engine hesitation or ignition-off may serve as a factor which lowers merchantability, and increase the time required for newly learning an air volume.

### SUMMARY

An aspect of the present disclosure is directed to a method and system for controlling an electronic throttle control (ETC) system of which carbon deposit is changed, which determines whether to apply an air volume learning value based on an existing opening degree of the ETC system at an initial stage of engine start, and applies an air volume learning value based on a new opening degree of the ETC system, when a difference between a target air volume and an actual air volume is large.

Another aspect of the present inventive concept is directed to a method and system for controlling an ETC system of which carbon deposit is changed, which removes a limit to a learning value for an opening degree of the ETC system, thereby correcting an air volume by the carbon deposit in the ETC system.

Other objects and advantages of the present disclosure can be understood by the following description, and become apparent with reference to the embodiments of the present inventive concept. Also, it is obvious to those skilled in the art to which the present disclosure pertains that the objects and advantages of the present disclosure can be realized by the means as claimed and combinations thereof.

In accordance with an exemplary embodiment of the present inventive concept, a method for controlling an ETC system is provided, in which an electronic control unit (ECU) controls the ETC system using an air volume learning value containing information on a volume of air introduced into an engine for each opening degree of the ETC system according to carbon deposit of the ETC system. The method includes reading an air volume learning value used during a previous operation. The air volume learning value is compared to a preset learning value change reference value. Whether an operation condition of the engine satisfies a learning value change condition which is preset to change the air volume learning value, and whether the volume of air passing through the ETC system satisfies a preset learning-value-change-air-volume condition are determined. The air volume learning value used during the previous operation and stored in the ECU is substituted with a preset initial value of the air volume learning value.

In the step of determining whether the operation condition of the engine satisfies the learning value change condition which is preset to change the air volume learning value, when a start elapsed time of the engine, whether start of the engine is completed, an engine revolutions per minute (RPM), and whether engine is idle, the ECU may perform the step of determining whether the volume of air passing through the ETC system satisfies the preset learning-value-change-air-volume condition.

When the start elapsed time of the engine, which is accumulated after the engine starts, is smaller than a preset learning-value-change start-elapsed-time threshold, the ECU may perform the step of determining whether the volume of air passing through the ETC system satisfies the preset learning-value-change-air-volume condition.

When the RPM of the engine is higher than a start completion RPM at which the start of the engine is completed, the ECU may determine that the start of the engine is completed, and perform the step of determining whether the volume of air passing through the ETC system satisfies the preset learning-value-change-air-volume condition.

When the RPM of the engine is smaller than a preset peak RPM reference value for each start temperature of the engine, the ECU may perform the determining whether the volume of air passing through the ETC system satisfies the preset learning-value-change-air-volume condition.

When a brake pedal is operated but an accelerator pedal for operation of the vehicle is not yet operated, after the engine starts, that is, when the engine is idle, the ECU may perform the step of determining whether the volume of air passing through the ETC system satisfies the preset learning-value-change-air-volume condition.

In the step of determining whether the volume of air passing through the ETC system satisfies the preset learning-value-change-air-volume condition, according to whether the start elapsed time of the engine is included in a learning-value-change start elapsed time, an air volume difference, and a counter cumulative time, the ECU may perform the step of substituting the air volume learning value used during the previous operation and stored in the ECU with the preset initial value of the air volume learning value.

When the start elapsed time of the engine falls between lower and upper limits of the preset learning-value-change start elapsed time, the ECU may perform the step of substituting the air volume learning value used during the previous operation and stored in the ECU with the preset initial value of the air volume learning value.

When a difference between an actual air volume measured through a manifold absolute pressure (MAP) sensor and a target air volume calculated through a throttle position sensor (TPS) is larger than a learning-value-change-air-volume difference which is preset according to a cooling air temperature, the ECU may perform the step of substituting the air volume learning value used during the previous operation and stored in the ECU with the preset initial value of the air volume learning value.

When the start elapsed time of the engine is included in the learning-value-change start elapsed time and the counter cumulative time satisfying the state in which the learning value change condition is satisfied according to the air volume difference is larger than a preset learning-value-change counter cumulative time, the ECU may perform the step of substituting the air volume learning value used during the previous operation and stored in the ECU with the preset initial value of the air volume learning value.

The method may further include controlling each opening degree of the ETC system by applying the air volume learning value used during the previous operation and stored in the ECU, when the air volume learning value is not larger than the learning value change reference value in the comparing the air volume learning value to the preset learning value change reference value.

The method may further include controlling each opening degree of the ETC system by applying the air volume learning value used during the previous operation and stored in the ECU, when the operation condition of the engine does not satisfy a learning-value-change entry operation condition, which is preset to change the air volume learning value, in the determining whether the operation condition of the engine satisfies the learning value change condition which is preset to change the air volume learning value.

The method may further include controlling each opening degree of the ETC system by applying the air volume learning value used during the previous operation and stored in the ECU, when the volume of air passing through the ETC system does not satisfy a preset learning-value-change-air-volume condition, in the step of determining whether the volume of air passing through the ETC system satisfies the preset learning-value-change-air-volume condition.

In accordance with another exemplary embodiment of the present inventive concept, a system for controlling an ETC system of which carbon deposit is changed includes a storage configured to store an air volume learning value used during a previous operation and the initial value of the air volume learning value, which is applied when the carbon deposit of the ETC system is changed. A controller is configured to determine whether the carbon deposit of the ETC system is changed using information inputted from a vehicle, to control an opening degree of the ETC system by applying the air volume learning value when the carbon deposit of the ETC system is changed, and to control the opening degree of the ETC system by applying the air volume learning value used during the previous operation when the carbon deposit of the ETC system is not changed.

The storage and the controller may be provided in an ECU.

### BRIEF DESCRIPTION OF THE DRAWINGS

FIGS. 1A and 1B are a block diagram illustrating a process in which an air volume is determined according to a vehicle torque requirement.

FIG. 2 illustrates a method for controlling an ETC system of which carbon deposit is changed in accordance with an embodiment of the present inventive concept.

FIGS. 3A to 3E are a block diagram illustrating logic for performing the method for controlling an ETC system of which carbon deposit is changed in accordance with the embodiment of the present inventive concept.

FIG. 4 illustrates a system for controlling an ETC system of which carbon deposit is changed.

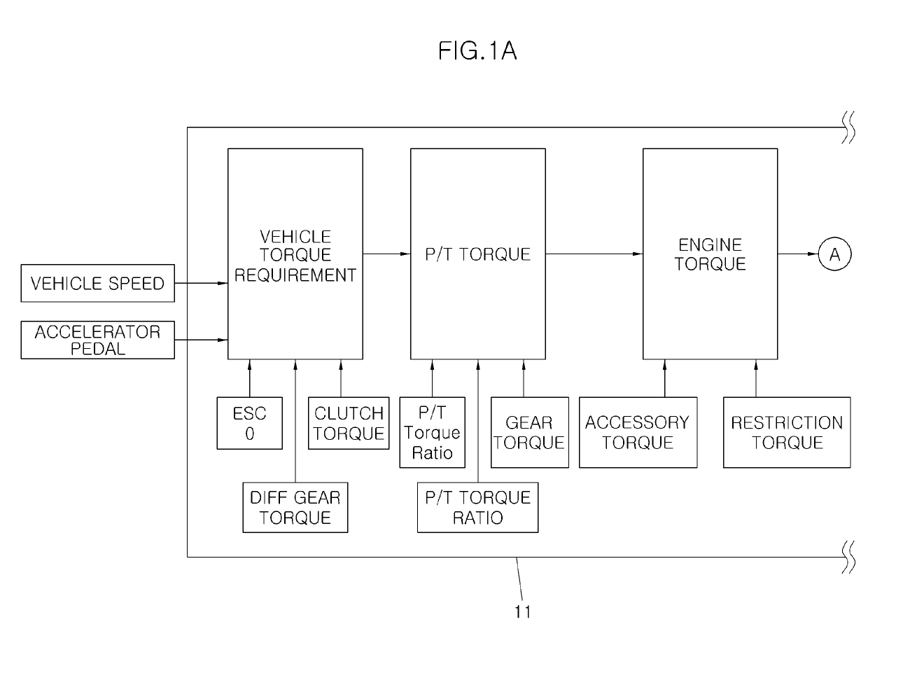

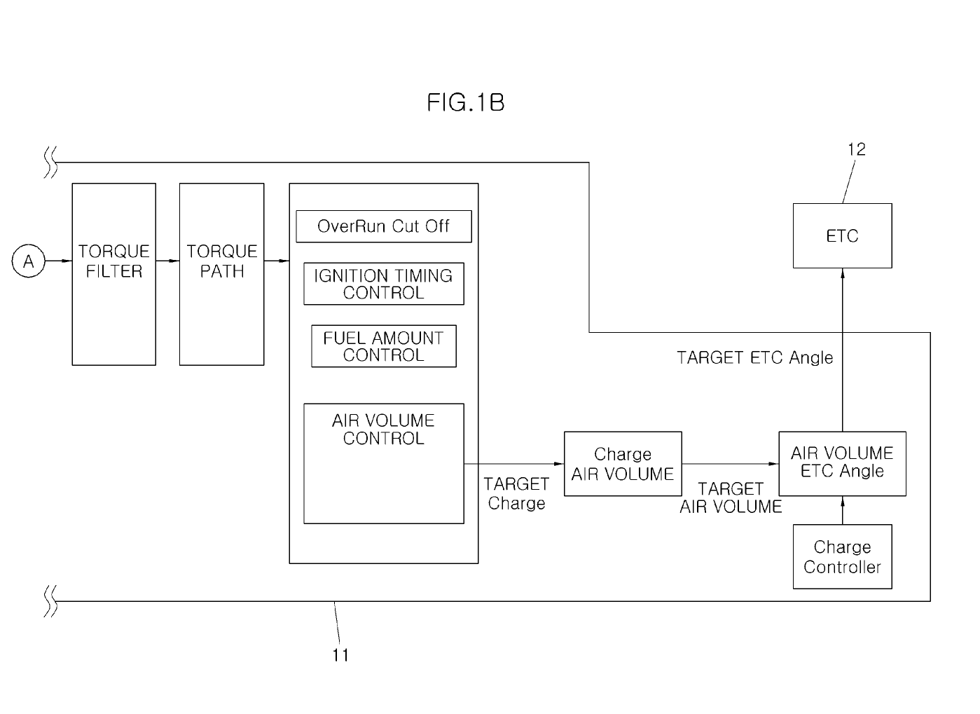

### DETAILED DESCRIPTION

Exemplary embodiments of the present inventive concept will be described below in more detail with reference to the accompanying drawings. The present inventive concept may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present inventive concept.

Hereafter, a method for controlling an electronic throttle control (ETC) of which carbon deposit is changed in accordance with an embodiment of the present inventive concept will be described in detail with reference to the accompanying drawings.

The method for controlling an ETC system of which carbon deposit is changed in accordance with the embodiment of the present inventive concept includes the following steps such that an electronic control unit (ECU) controls the ETC system using an air volume learning value which includes a volume of air introduced into an engine for each opening degree of the ETC system according to the carbon deposit of the ETC system. The method includes reading an air volume learning value used during a previous operation (S110) and comparing the air volume learning value to a preset learning value change reference value (S120). Whether an operation condition of an engine satisfies a preset learning value change condition is determined at which the air volume learning value is changed (S130). Whether the volume of air passing through the ETC system satisfies a preset learning-value-change-air-volume condition (S140). The air volume learning value, which was stored in the ECU and used during the previous operation, is substituted with a preset initial value of the air volume learning value (S150).

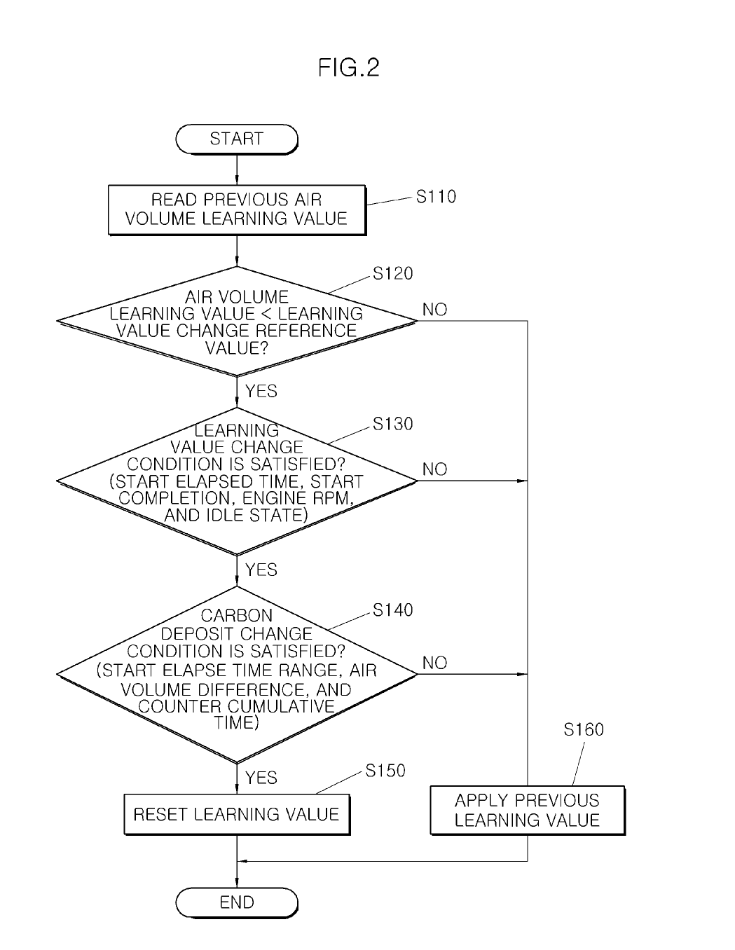

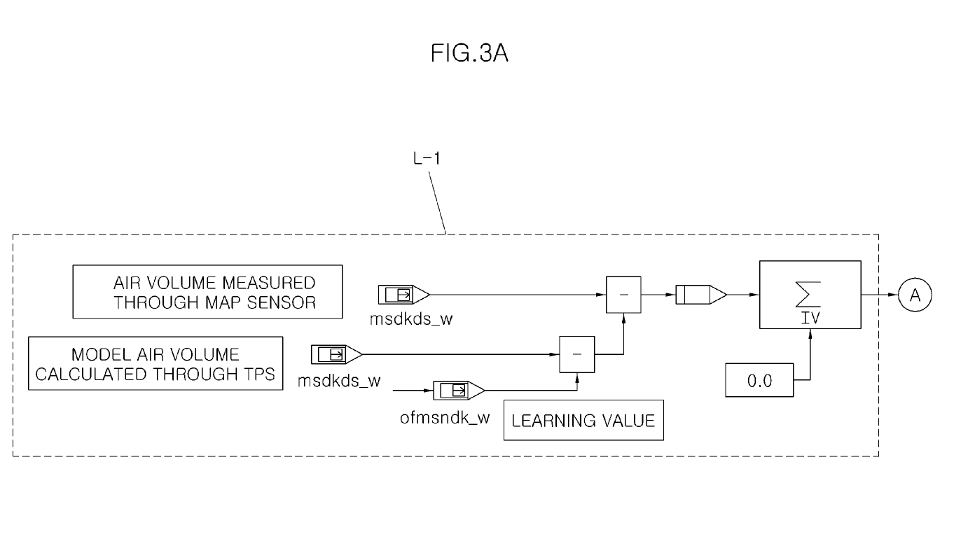

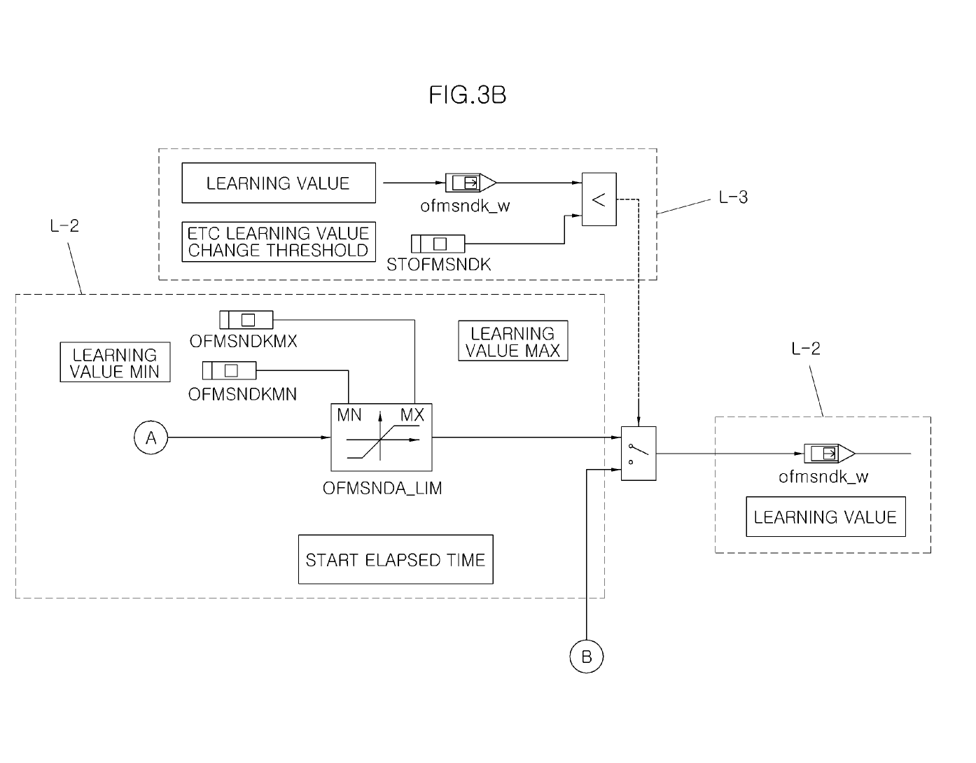

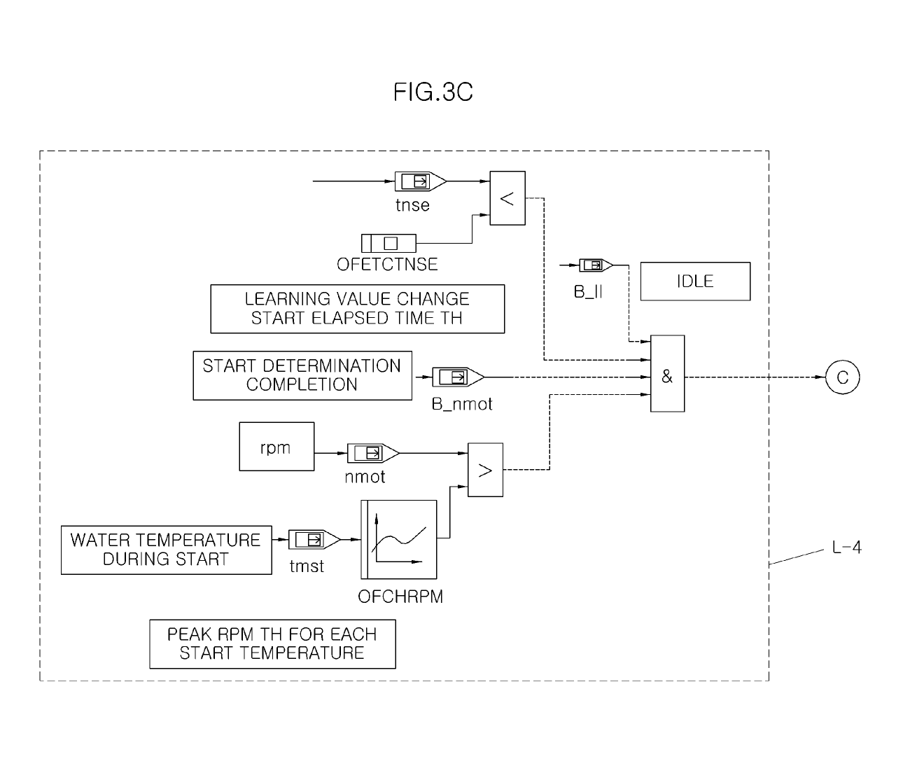

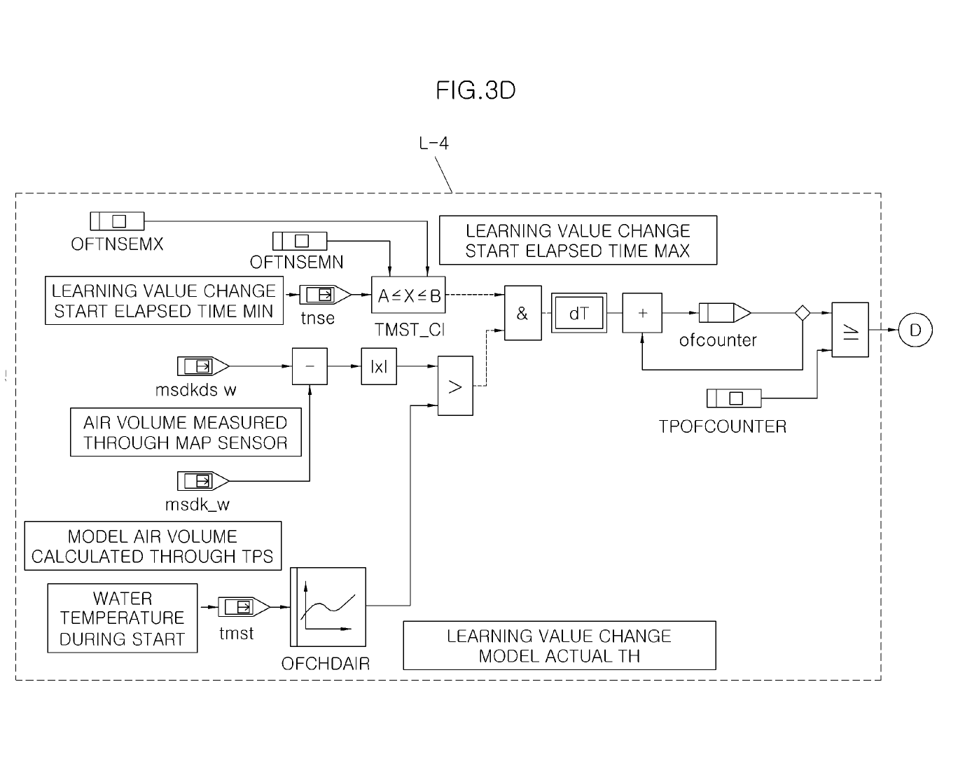

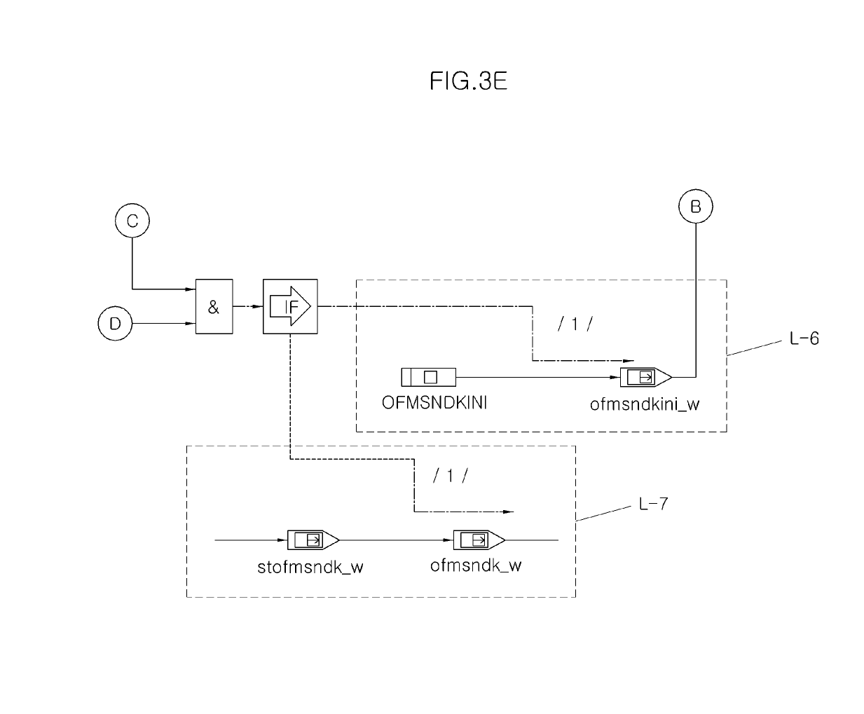

FIG. 2 illustrates the method for controlling an ETC system of which carbon deposit is changed in accordance with the embodiment of the present inventive concept, and FIGS. 3A to 3E illustrate a logic of the method.

At step S110, the air volume learning value used during the previous operation may be read after the vehicle starts. The air volume learning value includes information on the air volume for each opening degree of the ETC system according to the carbon deposit of the ETC system. The air volume learning value is stored in the ECU.

The ECU checks whether the air volume learning value used during the previous operation, which is inputted at step S110, is suitable through the following steps. Then, the ECU nearly learns an air volume by resetting the air volume learning value according to a preset condition, or controls the ETC system using the air volume learning value stored during the previous operation.

When the air volume learning value is inputted, the ECU calculates a corrected target air volume by applying the air volume learning value to the target air volume, calculates a difference between the corrected target air volume and an actual air volume (refer to L-1 of FIG. 3A), and determines whether the air volume learning value falls between the lower limit OFMSNDKMN and upper limit OFMSNDKMX of a preset air volume learning value (refer to L-2 of FIG. 3B).

At step S120, the ECU compares the air volume learning value used during the previous operation to the preset learning value change reference value STOFMSNDK as illustrated in L-3 of FIG. 3B. When the vehicle starts after the ETC system in which carbon is deposited is cleaned or replaced, an engine revolutions per minute (RPM) may be changed due to a difference in volume of air introduced into the engine, based on the carbon deposit before and after the cleaning or replacement. In this case, engine hesitation or ignition-off may occur. However, when the carbon deposit does not reach a predetermined level, the carbon deposit has almost no influence on the RPM and idle stability of the engine. Thus, the ECT determines whether the air volume learning value used during the previous operation is larger than the preset learning value change reference value, through step S120, and changes the air volume learning value only when the air volume learning value is larger than the preset learning value change reference value.

In particular, when the air volume learning value is frequently changed, engine hesitation or ignition-off may occur due to a rapid change of the air volume. Thus, the ECU compares the air volume learning value used during the previous operation to the preset learning value change reference value, and performs the following steps only when the air volume learning value is larger than the preset learning value change reference value.

Step S130 is performed only when the air volume learning value used during the previous operation is larger than the learning value change reference value (refer to L-4 of FIG. 3C). At step S130, the ECU determines whether the learning value change condition is satisfied, at which the learning value is to be changed. Step S130 is performed to determine whether to use the previous learning value or reset the air volume learning value within a predetermined time after the engine of the vehicle is started.

The learning value change condition is determined according to a time elapsed after the engine starts (hereafter, referred to as a start elapsed time), whether the start of the engine was completed, the engine RPM, and whether the engine is idle.

The ECU may compare the start elapsed time tnse of the engine to a preset learning-value-change start-elapsed-time threshold OFETCTNSE at which the learning value is changed, and change the learning value when the start elapsed time tnse of the engine is larger than the learning-value-change start-elapsed-time threshold OFETCTNSE. At step S130 which is performed at an initial stage of the engine start, the ECU determines whether to use the air volume learning value used during the previous operation or to apply a new air volume learning value, during operation of the vehicle. When the engine starts, the ECU compares the start elapsed time tnse of the engine to the learning-value-change start-elapsed-time threshold OFETCTNSE, and determines whether to change the air volume learning value, in order to remove a sense of incompatibility through quick diagnosis after the engine starts.

The ECU determines whether the start of the engine was completed, according to the engine RPM. The ECU compares the engine RPM to a preset start completion RPM, and determines that the start of the engine was completed, when the RPM of the engine is larger than the start completion RPM. The engine may maintain the start only when the RPM of the engine exceeds the start completion RPM. Thus, when the engine RPM is larger than the start completion RPM, the ECU may determine that the start of the engine was completed.

Furthermore, the ECU determines whether the RPM of the engine is smaller than a peak RPM reference value OFCHRPM which is set for each start temperature of the engine. When the RPM of the engine is smaller than the peak RPM reference value for each start temperature, which is set for each cooling water temperature according to a cooling water temperature tmst inputted during the start, the ECU may change the air volume learning value.

In order to determine whether the engine is idle, the ECU determines whether a brake pedal was operated by a driver and an accelerator pedal is not yet operated, after the engine starts. The method in accordance with the embodiment of the present inventive concept is performed at the initial stage after the vehicle is started. Specifically, the method is performed before the vehicle runs, that is, before the accelerator pedal is operated even though the brake pedal was operated. Thus, only when the engine is idle, the air volume learning value may be changed.

At step S130, the air volume learning value may be changed when one or more of the above-described four conditions are satisfied, that is, when one or more of the start elapsed time of the engine, whether the start of the engine was completed, the RPM of the engine, and whether the engine is idle are satisfied. However, only when all of the four conditions are satisfied, the air volume learning value may be changed.

At step S140, the ECU determines whether the volume of carbon deposited in the ETC system was changed in comparison to the previous operation. For example, when the ETC system was cleaned or replaced, no carbon may be deposited in the ETC system. In this case, when the air volume learning value used during the previous operation is used, a larger volume of air may be introduced into the engine at the same opening degree of the ETC system. Then, engine hesitation or ignition-off may occur. Thus, at step S140, the ECU checks whether the carbon deposit was changed, and determines whether to use the existing air volume learning value, or to apply a new air volume learning value.

For this operation, at step S140, the ECU determines whether the start elapsed time tnse of the engine falls within a preset learning-value-change start elapsed time, according to the air volume difference and a counter cumulative time (refer to L-5 of FIG. 3D).

For example, only when the start elapse time tnse of the engine falls between the lower limit OFTNSEMN and the upper limit OFTNSEMX of the learning-value-change start elapsed time, step S140 is performed.

Furthermore, when the air volume difference, that is, the difference between the target air volume and the actual air volume is larger than a learning-value-change-air-volume difference OFCHDAIR which are preset for each cooling water temperature, step S140 is performed. The ECU compares the target volume msdk_w of air, which is to be introduced into the engine to exhibit an engine torque requirement, to an actual volume msdkds_w of air which is actually introduced into the engine. When a difference between the two air volumes is larger than the learning-value-change-air-volume difference for each cooling water temperature, step S140 is performed. The actual air volume may be measured through a manifold absolute pressure (MAP) sensor, and the target air volume may be calculated according to the opening degree of the throttle valve, measured by a throttle position sensor (TPS).

Furthermore, the ECU compares the counter cumulative time ofcounter to a preset learning-value-change counter cumulative time TPOFCOUNTER. More specifically, the counter cumulative time measured from the time at which the above-described two conditions, that is, the start elapsed time of the engine and the air volume difference are included in preset conditions may be compared to a learning-value-change counter cumulative time.

When the start elapsed time of the engine is included in the learning-value-change counter cumulative time or the air volume difference is larger than the learning-value-change-air-volume difference for each cooling water temperature, the ECU may determine that the carbon deposit of the ETC system was changed. However, the ECU compares the counter cumulative times, in order to determine whether the carbon deposit was temporarily changed by disturbance or the like or whether the carbon deposit was actually changed.

At step S150 which is performed when all of the conditions of the above-described steps are satisfied, the air volume learning value stored in the ECU 11 is reset to the preset initial value (refer to L-7 of FIG. 3E). That is, when it is determined that the air volume learning value is larger than the learning value change reference value, the operation condition of the engine satisfies the learning value change condition, and the carbon deposit of the ETC system was changed, the air volume learning value used during the previous operation and stored in the ECU is reset to the preset air volume learning value OFMSNDKINI.

At step S160 which is performed when any one of the conditions of the above-described steps is not satisfied, the air volume learning value used during the previous operation and stored in the ECU is used to control the ETC system (refer to L-7 of FIG. 3E). That is, when it is determined that the air volume learning value is not larger than the learning value change reference value, the operation condition of the engine does not satisfy the learning value change condition, and the carbon deposit of the ETC system was not changed, the air volume learning value used during the previous operation and stored in the ECU is used to control the ETC system.

As described above, when it is determined through the series of processes that the carbon deposit of the ETC system was changed due to cleaning or replacement of the ETC system, within a predetermined time, the ECU may reset the air volume learning value. Otherwise, the ECU may controls the opening degree of the ETC system using the air volume learning value used during the previous operation (refer to L-8 of FIG. 3B).

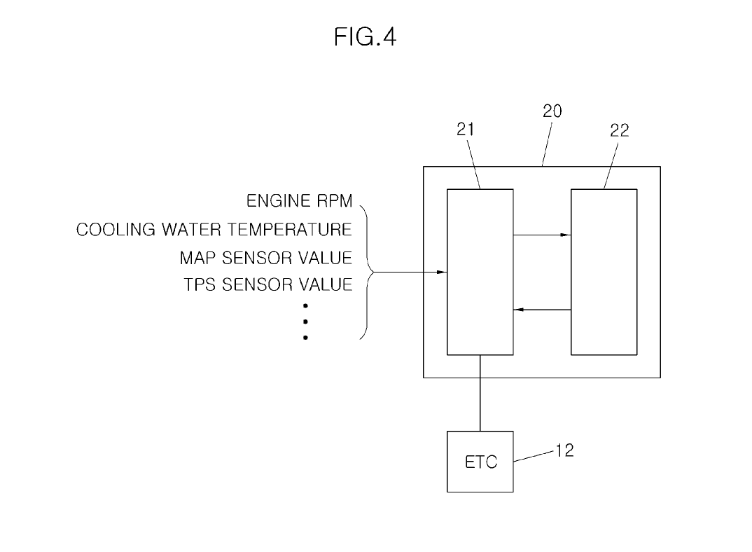

FIG. 4 illustrates a system for controlling an ETC system of which the carbon deposit is changed, which performs the method for controlling an ETC system of which carbon deposit is changed in accordance with the embodiment of the present inventive concept.

As illustrated in FIG. 4, the control system 20 for controlling an ETC system of which the carbon deposit is changed in accordance with the embodiment of the present inventive concept includes a storage 22 and a controller 21. The storage 22 is configured to store an air volume learning value used during the previous operation and an air volume learning value initial value applied when the carbon deposit of the ETC system was changed. The controller 21 is configured to determine whether the carbon deposit of the ETC system was changed, using information inputted from the vehicle, control the opening degree of the ETC system by applying the air volume learning value when the carbon deposit of the ETC system was changed, and control the opening degree of the ETC system by applying the air volume learning value used during the previous operation when the carbon deposit of the ETC system was not changed.

The controller 21 determines whether to change the air volume learning value based on the information inputted from the vehicle, and controls the ETC system using the reset air volume learning value or the air volume learning value used during the previous operation, according to whether the air volume learning value was changed. The information inputted to the controller 21 may include an engine RPM, a cooling water temperature from the start time to the current time, an MAP sensor value, and a TPS value. The MAP sensor value and the TPS value are inputted to calculate a target volume of air to be introduced into the engine and an actual volume of air introduced into the engine. The RPM of the engine is inputted to determine whether the engine was started or whether the RPM of the engine exceeded a peak RPM for each cooling water temperature.

The storage 22 stores the air volume learning value used during the previous operation and the initial value of the air volume learning value, which is applied when the air volume is intended to be newly learned. When the controller 21 determines to use the air volume learning value used during the previous operation or to apply a new air volume learning value, based on the input information, the controller 21 reads the air volume learning value used during the previous operation or the initial value of the air volume learning value from the storage 22, and controls the ETC system using the read air volume learning value.

The controller 21 and the storage 22, which constitute the system for controlling an ETC system of which carbon deposit is changed in accordance with the embodiment of the present inventive concept, perform the method for controlling an ETC system of which carbon deposit is changed, the method being stored in the ECU.

In accordance with the exemplary embodiments of the present invention, when the carbon deposit of the ETC system is changed, for example, when the ETC system is cleaned or replaced, the method and system for controlling an ETC system of which carbon deposit is changed may determine whether to apply the air volume learning value used during the previous operation and whether the carbon deposit was changed, and reset the air volume learning value to newly learn an air volume based on the carbon deposit, thereby preventing engine hesitation or ignition-off.

Furthermore, as the optimal combustion condition is maintained, exhaust gas and fuel efficiency may be improved, and noise and vibration may be reduced.

While the present inventive concept has been described with respect to the specific embodiments, it will be apparent to those skilled in the art that various changes and modifications may be made without departing from the spirit and scope of the invention as defined in the following claims.

What is claimed is:

1. A method for controlling an electronic throttle control (ETC) system, in which an electronic control unit (ECU) controls the ETC system using an air volume learning value containing information on a volume of air introduced into an engine for each opening degree of the ETC system according to carbon deposit of the ETC system, the method comprising steps of:
reading an air volume learning value used during a previous operation;
comparing the air volume learning value to a preset learning value change reference value;
determining whether an operation condition of the engine satisfies a learning value change condition which is preset to change the air volume learning value;
determining whether the volume of air passing through the ETC system satisfies a preset learning-value-change-air-volume condition; and
substituting the air volume learning value used during the previous operation and stored in the ECU with a preset initial value of the air volume learning value.

2. The method of claim 1, wherein in the step of determining whether the operation condition of the engine satisfies the learning value change condition which is preset to change the air volume learning value,
when a start elapsed time of the engine, whether start of the engine is completed, an engine revolutions per minute (RPM), and whether the engine is idle, the ECU performs the step of determining whether the volume of air passing through the ETC system satisfies the preset learning-value-change-air-volume condition.

3. The method of claim 2, wherein when the start elapsed time of the engine, which is accumulated after the engine starts, is smaller than a preset learning-value-change start-elapsed-time, the ECU performs the step of determining whether the volume of air passing through the ETC system satisfies the preset learning-value-change-air-volume condition.

4. The method of claim 2, wherein when the RPM of the engine is higher than a start completion RPM at which the start of the engine is completed, the ECU determines that the start of the engine is completed, and performs the step of determining whether the volume of air passing through the ETC system satisfies the preset learning-value-change-air-volume condition.

5. The method of claim 2, wherein when the engine RPM is smaller than a preset peak RPM reference value for each start temperature of the engine, the ECU performs the step of determining whether the volume of air passing through the ETC system satisfies the preset learning-value-change-air-volume condition.

6. The method of claim 2, wherein when a brake pedal is operated but an accelerator pedal for the vehicle is not operated, after the engine starts, that is, when the engine is idle, the ECU performs the step of determining whether the volume of air passing through the ETC system satisfies the preset learning-value-change-air-volume condition.

7. The method of claim 1, wherein in the step of determining whether the volume of air passing through the ETC system satisfies the preset learning-value-change-air-volume condition,
according to whether the start elapsed time of the engine is included in a learning-value-change start elapsed time, an air volume difference, and a counter cumulative time, the ECU performs the step of substituting the air volume learning value used during the previous operation and stored in the ECU with the preset initial value of the air volume learning value.

8. The method of claim 7, wherein when the start elapsed time of the engine falls between lower and upper limits of the preset learning-value-change start elapsed time, the ECU performs the step of substituting the air volume learning value used during the previous operation and stored in the ECU with the preset initial value of the air volume learning value.

9. The method of claim 7, wherein when a difference between an actual air volume measured through a manifold absolute pressure (MAP) sensor and a target air volume calculated through a throttle position sensor (TPS) is larger than a learning-value-change-air-volume difference which is preset according to a cooling air temperature, the ECU performs the step of substituting the air volume learning value used during the previous operation and stored in the ECU with the preset initial value of the air volume learning value.

10. The method of claim 7, wherein when the start elapsed time of the engine is included in the learning-value-change start elapsed time and the counter cumulative time satisfying when the learning value change condition is satisfied according to the air volume difference is larger than a preset learning-value-change counter cumulative time, the ECU performs the step of substituting the air volume learning value used during the previous operation and stored in the ECU with the preset initial value of the air volume learning value.

11. The method of claim 1, further comprising a step of:
controlling each opening degree of the ETC system by applying the air volume learning value used during the previous operation and stored in the ECU when the air volume learning value is equal to or smaller than the learning value change reference value in the comparing the air volume learning value to the preset learning value change reference value.

12. The method of claim 1, further comprising a step of:
controlling each opening degree of the ETC system by applying the air volume learning value used during the previous operation and stored in the ECU, when the operation condition of the engine does not satisfy a learning-value-change entry operation condition, which is preset to change the air volume learning value, in the step of determining whether the operation condition of the engine satisfies the learning value change condition which is preset to change the air volume learning value.

13. The method of claim 1, further comprising a step of:
controlling each opening degree of the ETC system by applying the air volume learning value used during the previous operation and stored in the ECU, when the volume of air passing through the ETC system does not satisfy a preset learning-value-change-air-volume condition, in the step of determining whether the volume of air passing through the ETC system satisfies the preset learning-value-change-air-volume condition.

14. A system for controlling an ETC system of which carbon deposit is changed, comprising:
a storage configured to store an air volume learning value used during a previous operation and an initial value of the air volume learning value, which is applied when the carbon deposit of the ETC system is changed; and
a controller configured to determine whether the carbon deposit of the ETC system is changed, using information inputted from a vehicle, to control an opening degree of the ETC system by applying the air volume learning value when the carbon deposit of the ETC system is changed, and to control the opening degree of the ETC system by applying the air volume learning value used during the previous operation when the carbon deposit of the ETC system is not changed.

15. The system of claim 14, wherein the storage and the controller are provided in an ECU.
